(19) United States
(12) Patent Application Publication
(10) Pub. No.: US 2009/0083176 A1
(43) Pub. Date: Mar. 26, 2009

(54) METHODS FOR ALLOCATING RISKS OF FUTURE MAJOR DEVELOPMENTS

(76) Inventors: Richard SANDOR, Chicago, IL (US); Michael Walsh, Downers Grove, IL (US)

Correspondence Address: WINSTON & STRAWN LLP;PATENT DEPARTMENT, 1700 K STREET, N.W., WASHINGTON, DC, 20006, US

(21) Appl. No.: 12/263,050

(22) Filed: Oct. 31, 2008

Related U.S. Application Data
(63) Continuation-in-part of application No. PCT/US08/51457, filed on Jan. 18, 2008.
(60) Provisional application No. 60/885,739, filed on Jan. 19, 2007.

(51) Int. Cl. G06Q 40/00

(52) U.S. Cl. 705/37

(57) ABSTRACT

Computer-implemented methods for allocating risks from major developments are described. The methods include identifying one or more future major developments with economic impact; identifying a parameter to indicate that each of the developments has or has not occurred; creating a contractual instrument that is based on the occurrence or non-occurrence of the one or more major developments; and trading the instrument. A contractual instrument based upon on an occurrence or non-occurrence of one or more major developments in electronic form and tradable in the methods is also described.

This application is a continuation-in-part of International application PCT/US08/51457 filed Jan. 18, 2008, which claims the benefit of provisional application 60/885,739 filed Jan. 19, 2007, the entire content of each of which is expressly incorporated herein by reference thereto.

### BACKGROUND OF THE INVENTION

Significant economic value and risk is associated with changes in law or regulation, judicial and electoral outcomes, treaties and embargos, major events or transactions of governmental or business entities, wars and acts of terrorism, strikes and labor shortages, and other major developments. The occurrence and/or non-occurrence of certain combinations of major developments within the same time period can increase economic consequences by orders of magnitude. These types of developments frequently impose significant economic consequences on a broad segment of the marketplace and can lead to important public policy changes. As a matter of routine, these developments constitute existing risks to industry, agriculture, governments, financial enterprises, fisheries, forestry, energy systems and numerous other economic entities.

An example of a public policy development is a federal level legislative action that imposes environmental requirements, such as caps on carbon dioxide emissions. Many entities in the energy, manufacturing and transportation sectors would face increased environmental compliance costs, while entities that provide technologies that reduce or mitigate carbon emissions would see increased business opportunities in such a setting. Currently, there is no suitable and focused financial mechanism that allows the transfer of the risks associated with such major developments from those who face economic risks from the developments to those entities that are willing to accept the risks. The present invention provides such a mechanism and meets this need.

### SUMMARY OF THE INVENTION

The present invention relates to a computer-implemented method for electronic trading of contractual instruments that allocate risks based on the occurrence or non-occurrence of one or more major developments. The method includes identifying one or more future major developments with economic impact, generating one or more digital parameters for each of the developments to indicate whether the major development has or has not occurred, creating a tradable contractual instrument that is based on the occurrence or non-occurrence of the identified one or more developments, and providing electronic trading the instrument between buyers and sellers, with the societal benefit of such systems being the ability to transfer significant economic risks from those who wish to reduce exposure to those who can and will absorb such economic exposure.

It is noted that the occurrence and/or non-occurrence of a plurality of major developments could be identified in one instrument. For the sake of simplicity, “occurrence or non-occurrence” of a major development shall hereinafter in this specification be referred to as “occurrence.” Further for the sake of simplicity, references to a “development” or a “major development” shall, to the extent context permits in this specification, include combinations of multiple major developments which may be specified in an instrument.

In one embodiment, a major development has a significant economic impact and includes one or more of natural resource access and usage; commodity or financial regulatory actions that influence prices and volume of trade; intellectual property protection; international relations; energy price regulations; tax rates and coverage; insurance programs; research and development support; or program expenditures. Such developments may take the form of changes in government, actions by legislative, judicial, regulatory bodies, international agreements, election outcomes, or other observable events.

In another embodiment, a major development has a significant economic impact and includes a major event or transaction involving a governmental or business entity the operation of which has widespread financial or public welfare implications, such as a default on a business contract, a natural disaster, a bankruptcy filing, or an associated finding of a court or jury.

In most embodiments, there is one or more parameter for each of the one or more future developments that has a quantifiable dimension that is evidence of the occurrence of the development, that can be specified by suitably qualified experts and/or take the form of clearly observable events.

Preferably, the method also includes assigning an expiration date for the contractual instrument to facilitate trading and risk transfer within specified time periods. A series of instruments can be created so that they expire on a sequence of future dates.

In a preferred embodiment, the contractual instrument includes a spot contract as well as a futures or options contract. Typically, the method also includes fostering, through the interaction of supply and demand in an organized market mechanism, discovery of contract market prices for the contractual instrument through facilitation of trade. Monitoring the contract market price during a trading day is usually also included in the method.

The method also generally includes determining whether the major development has occurred. In most embodiments, there is one or more digital parameters for a major development that has a quantifiable dimension that indicates whether or not the development has occurred. The determination of the value of a parameter or parameters may be made by observation or any other suitable means, for example, by a committee of experts, and the decision is communicated to parties that have traded the instrument.

The mechanism establishes an insurance-like instrument with a payment process that provides compensation to one party to a risk-transfer transaction so that the entity that receives such contingent payment (i.e. the payment is contingent upon the occurrence of a major development) can use the received funds to mitigate the burden it faces as a result of economic impacts due to the specified outcome.

The method may also include providing payment instructions for triggering a payment of an amount specified in the instrument to a holder upon a determination that the development has occurred. The payment to the holder of the instrument may be scaled depending upon how far the public policy action surpasses or falls short of a numeric benchmark. The identifying of the future public policy action may be based on a probability, scale, and time frame associated with the action.

The present invention also relates to a contractual instrument based upon on an occurrence of a major development, which instrument is in electronic form and is tradable in the present methods.

### BRIEF DESCRIPTION OF THE DRAWINGS

FIGS. 1A and 1B together form a diagrammatic representation of an exemplary method according to the invention.

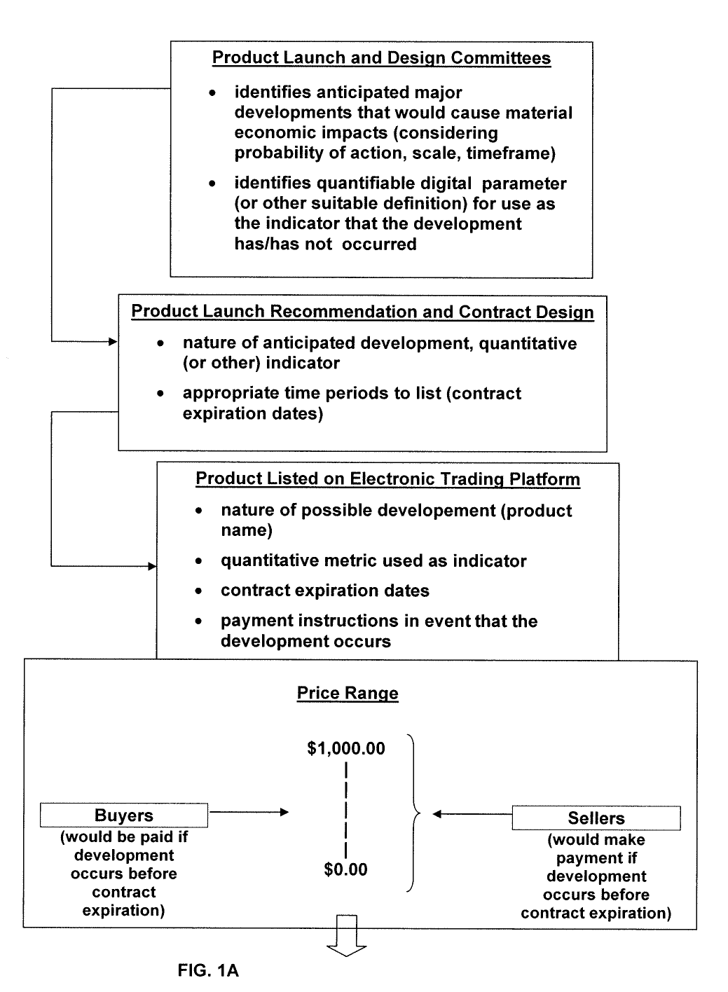

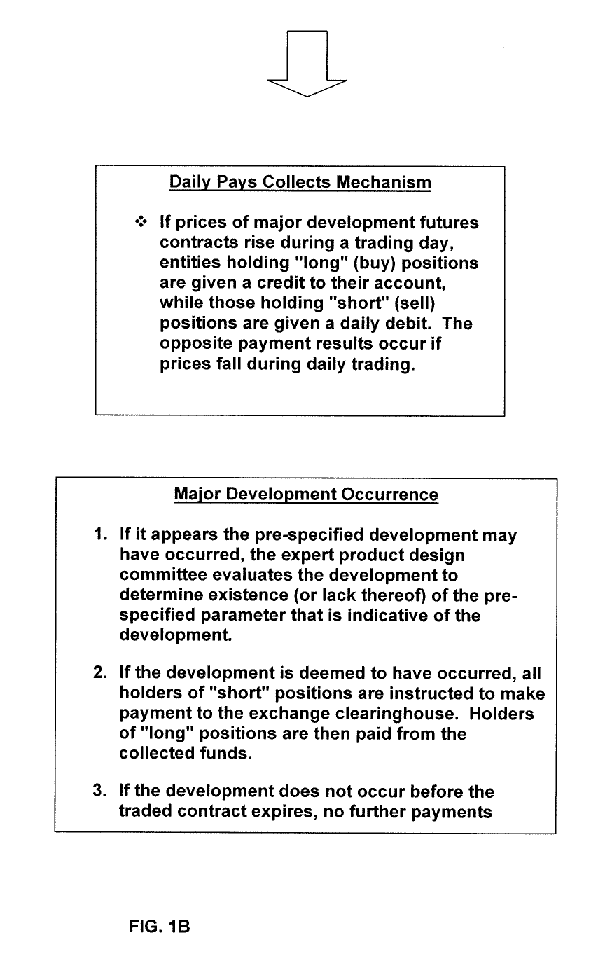

### DETAILED DESCRIPTION OF THE PREFERRED EMBODIMENTS

The present invention provides a market-based contractual mechanism that allows the transfer of already-existing risks from particular, specified major developments from those who face economic risk from such events, to those financial and investor agents that are willing to accept such risks. The contractual instruments may be traded on an organized exchange, but also in other market forum such as through private, over-the-counter trades, as products offered by banking and investment institutions.

The organized exchange can include a system for facilitating trading between parties. The system can include a registry, a guarantee mechanism, and a trading host or platform. The system can be coupled to a network, such as the Internet or any other public or private network or connections of computing devices.

The trading platform is an electronic mechanism for hosting market trading that provides participants with a central location that facilitates trading, and publicly reveals market price information. The trading platform reduces the cost of locating trading counter parties and finalizing trades, an important benefit in a new market.

In an exemplary embodiment, the registry is designed to provide secure Internet access by entities or participants to their own accounts. The registry may be configured to provide access to certain information by the public, but this access would be on a read-only basis. The registry is linked to the trading platform and financial guarantee mechanism. The combination of these three components provides a clearinghouse system.

The traded contractual instruments, which preferably are in the form of futures or options contracts, may also be the basis of spot contracts, swap contracts, swaptions, mutual funds, bonds, equity securities and all such related derivative and other instruments that have a price, return, dividend, or other financial performance that is based on the existence or non-existence of a possible future major development.

A major development as used herein means a development that has far reaching implications that impose financial implications on a large segment of the population. These types of developments frequently impose significant economic consequences on a broad segment of the marketplace and can lead to important public policy changes. As an example, the nature of the major development that may be used in the present methods include economically significant actions that influence already-existing risks in topical areas such as, but not limited to, natural resource access and usage (fisheries, forestry, mining, energy resources); commodity or financial regulatory actions that influence prices and volume of trade; intellectual property protection (e.g., copyright or patent infringements); international relations such as trade agreements, tariff levels, boycotts or other trade restrictions or prohibitions; energy price regulations; tax rates and coverage; insurance programs, such as medical insurance premiums, payout or pricing rules; research and development support; specific program expenditures (e.g., the annual budget of the U.S. Department of Defense); or military or diplomatic actions (e.g., declarations of war, granting of enhanced military authority to the executive branch or defense department, specific and independently verifiable military actions).

A major development could also relate to a major event or transaction involving a governmental or business entity the operation of which has widespread financial or public welfare implications. The entity could be a highly regulated entity such as a bank, insurance company, hedge fund, broker-dealer or other financial services firm or product. The entity could be a government regulator or agency that implements or administers laws or government policies. The entity may also be a public or non-public company that employs large numbers of people, buys large volumes of materials from suppliers, or provides goods or services to the marketplace that are essential or in large volume. The development could be a bankruptcy filing, reorganization, liquidation, split, divestiture, combination, merger, takeover, acquisition or the like. The development may be a major event or transaction such as signing a financially significant business deal, change of management, employee layoff, earnings announcement or performance, default or other contractual non-performance, legal problem, liability, court decision, redeployment of resources, natural disaster, change of plans or responsibilities, receiving guarantees, financial support or debt forgiveness from the U.S. Government, or other event or transaction that has widespread financial or public welfare implications.

A further example of a major development is medical regulations imposed by a state or provincial health agency that imposes price caps on specific medical products. Entities that invent (at great cost), produce and sell such medical products may see reduced profits as a result of such price caps, while insurance companies that reimburse for outlays on medicine would see lower reimbursement costs and potentially higher profits. The present methods provide the mechanism for the transfer of risk of the occurrence of such developments from medical product suppliers and health insurers to other parties willing to bear those risks.

Other examples of a major development are the election of specific individuals and election results that lead to significant changes in regulatory or tax policies. The election of a specific leader can have the effect of causing changes in policies that have specific economic impact on certain industries. An example of a clearly observable event includes change of control of the partisan composition of a legislature or parliament is likely to lead to tax policy changes (e.g., changes in estate taxes).

Moreover, a full range of major developments may be integrated into the traded financial instrument. These could include, but are not limited to: court decisions; budget and tax policy decisions; election results; legislative actions, decisions or interpretations of regulatory bodies at state, federal, provisional or municipal levels, including multi-state compacts; entry into force of international treaties, compacts or other legal instruments involving sovereign nations; or modifications and amendments to treaties, decisions by international legal bodies (e.g., by administrative bodies of the North America Free Trade Agreement or United Nations Secretariats). As stated above, instruments could be created that specify the occurrence of a combination of major developments, including that one or more major developments occur and one or more other major developments do not occur.

The traded contractual instrument is typically, but not always linked to the occurrence of a major development that has a quantifiable dimension to it (e.g., a percentage of an industry becomes subject to a regulation, a specified price level is embodied in a rule, a regulation takes effect before or after a specified date). Further, the instrument is usually listed for trade with an expiration date. The expiration date may be set for a number of contracts (based on the same major development) to include a sequence of differing future deadlines. For example, the contracts could cause payment to be triggered if the pre-specified development occurs before Jan. 1, 2009 in one contract, or before Jan. 1, 2010 in another contract, or before Jan. 1, 2011 in yet another, and so on. The relative market prices of contracts for these differing time periods would constitute useful information to the public and affected entities as it would be a reflection of the composite of expectations of market participants as to the likelihood that the pre-specified development would or would not occur during different timeframes.

The present method preferably includes designating a contract market price for the contractual instrument to facilitate trading. The contract market price should generally be monitored during a trading day. If the market price of the contract rises during a trading day, entities holding “long” or buy positions are given a credit to their account, while those holding “short” or sell positions are given a daily debit. On the other hand, if the market price of the contract falls during a trading day, entities holding “long” positions are given a debit, and those holding “short” positions are given a credit.

The nature of the traded instrument is a financial contract that involves the payment by one party to a transaction to the other party if a pre-specified major development occurs or does not occur. The traded instrument is preferably in electronic form. The parties enter into the transaction because each may have a different exposure to the economic implications of the development, or may have a different opinion as to the likelihood of such a development taking place. Because the instrument will trigger a payment process upon the occurrence of the pre-specified development, economically interested parties can use the instrument as a financial hedge such that the receipt of the payment helps reduce the net economic impact imposed by the development.

The market price of the traded instrument will reflect the interaction between those who believe there is a relatively high (or rising) probability that a pre-specified major development will occur and those who believe there is a relatively low (or falling) likelihood that the pre-specified major development action will occur. There is a binary nature to the payout decision: if the pre-specified development occurs, it may be further specified that the buyer of the contract is to be paid the designated contract value. In such event, all holders of “short” or sell positions are instructed to make payment to the exchange clearinghouse. Holders of “long” or buy positions are then paid from these collected funds. Correspondingly, if the development does not occur before the contract expires, no payout occurs, the seller of the contract receives the market price agreed when the contract was sold. Contracts that provide a scaled payment—one calibrated to the extent by which an event surpasses or falls short of a numerical benchmark—may also be used.

To further illustrate, a policy issue that may be used as the basis for the traded instrument may be the passage of a law in the U.S. that places limits on the allowed release of carbon dioxide emissions. The various terms of the contract are as follows: the law would have to be signed by the President of the United States before midnight eastern U.S. time on Dec. 31, 2009; legal challenges to the law after signature by the President, or subsequent adoption of laws that alter the impacts of the original law would not invalidate the determination that the original law in question was in fact passed; the contract value is $1,000 paid by the seller to the buyer of the contract if the development occurs; the contract market price range is $0 to $1,000. The contract market price increments are $10 per contract. The parameter (in this case quantifiable) used to determine the existence of the law (major development) is that more than 5% of total U.S. carbon dioxide emissions become subject to quantified emission limits. The determination that the major development in question in fact occurred is made by a committee of independent experts who are capable of identifying the existence, or lack thereof, of the triggering action (i.e., that the law means that more than 5% of total U.S. carbon dioxide emissions become subject to quantified emission limits). Once the committee determines the existence of the development, this information is communicated to the relevant parties so that payment arrangements may be made.

An entity that could potentially be interested in such a contract is an electric utility company. An electric utility company expects to face significantly increased operating costs if the environmental law described above is passed. In such case, it would take a “buy” position in the contract as a means of offsetting the negative economic impact associated with the law. On Jan. 10, 2009, the market price of this particular contract is $300. In a liquid market, that market price could be considered to be a reflection of a consensus among market participants that there is a 30% chance that the law would pass before the midnight Dec. 31, 2009 contract expiration time. If the electric utility in question purchased the contract on Jan. 10, 2009 for $300 and the law in fact was signed by the President before the midnight Dec. 31, 2009 contract expiration time, the seller of the contract would pay the electric utility $1,000. If the contract expiration time arrives and that specified policy action has not occurred, the contract expires with the contract would be settled with the seller of the contract receiving the previously agreed $300, and no further payment would be made by the seller to the buyer of the contract. An investor might also buy such a contract if it thought there was a better than 30% change of the law being passed.

There are two reasons why a seller would enter into such a contract at a market price of $300: first, as a hedge, or second, as an informed investment. As a hedge, the seller of the contract may be in the business of producing equipment for sale and use to reduce carbon dioxide emissions which would realize economic gain if the law is passed. In order to position itself to realize some economic benefit even if the law does not pass, it could sell such a contract and (if the law does not pass) retain the agreed market price of the contract and reduce its net economic loss that results from non-passage of the law.

A “sell” trade could also reflect an informed investment decision. The seller may have high confidence that the law in question will not be passed, and may view the opportunity to realize income through sale of the contract as economically attractive.

Because the seller is required to make payment if the pre-specified policy action occurs, the act of selling in effect represents an assumption of economic risk by the seller from the buyer. The existence of such a risk transfer mechanism can provide societal benefit because it increases overall economic efficiency since those seeking to reduce risk now have a vehicle for doing so (at low transaction cost).

Consider also a scenario where the likelihood of the public policy action changes during the period covered by the contract. On Jan. 10, 2009, the market price of the contract described above is $300. Suppose the electric utility has purchased one contract at a market price of $300. Thereafter, events transpire that influence the likelihood of passage of the law in question and market participants that trade the contract collectively believe (and express such belief through buying and selling of the contracts at a higher market price) that the likelihood of passage of the law has increased. Such influential events could include changed composition of congressional committees, international or ecological incidents, etc. In this scenario, the market price for the contract then may rise to $400. This would imply that buyers and sellers believe the chance of realizing the $1,000 payout has increased to 40%, and that sellers would be willing to take the risk of having to pay the $1,000 only if they receive the higher payment in return for the additional risk.

The electric utility that holds the contract it had purchased at a market price of $300 could, if it so chooses, sell an identical or nearly identical contract to other market participants at the current market price of $400. It would then have no net position in the market, and would realize a profit of $100. It might choose to do so if it felt that profit amount provided a reasonable amount of financial benefit to offset the risk that the policy action may occur, or perhaps it has a different view as to the significance of the influential developments to the possible emergence of the policy action. In any event, as the apparent risk of the policy action has increased, the electric utility realized an effective hedge. It took a position in the market that offset the risk of increased costs due to the passage of the law, the risk remained protected at the agreed market price even though the likelihood of the event changed (as reflected by the increased market price of the contract). When it decided to sell the contract it received financial compensation, which could then be dedicated to investments to reduce emissions in anticipation of such requirements

The trading of such contracts can be conducted in a manner known in the art, such as that described in copending US application publication 2005/0246190, the content of which is expressly incorporated herein by reference to the extent necessary.

Note that any of the functions, method steps or processes of the invention can be performed by one or more hardware or software devices, processes or other entities. These entities can reside in the same location or can reside remotely, for example, as entities interconnected by a digital network such as the Internet, a local area network (LAN), campus or home network, standalone system, etc. Although functions may have been described as occurring simultaneously, immediately or sequentially, other embodiments may perform the functions, steps or processes in a different order, or at substantially different times with respect to execution of other functions, steps or processes.

It will be understood that the systems and software described herein include, either explicitly or implicitly, software implemented on computers or other appropriate hardware, including such other intelligent data processing devices having processors, data storage means, and the ability to support an operating system, with or without user interfaces, for example, file servers, as may be useful in implementing this invention.

Preferred embodiments of the invention provide program product, which can cause a general-purpose computer to operate as a special-purpose computer, in accordance with the disclosure herein. Such program product implemented on a general-purpose computer constitutes an electronic customizing machine that can interact with a magnetically or optically cooperative computer-based input device enabling the computer to be customized as a special purpose computer, according to the contents of the software. To cause a computer to operate in such a customized, special-purpose mode, the software can be installed by a user or some other person, and will usually interact efficiently with the device on which it resides to provide the desired special-purpose functions or qualities, but only after the selection of configuration details which are often unique to the operating system(s) used by the computer. When so configured, the special-purpose computer device has an enhanced value, especially to the commercial users for whom it may be intended.

It is to be understood that the terms “computer,” “server,” “data storage means,” as well as cognate terms, denote either physical or logical instances of those entities. For instance, a computer, data storage means and server may be implemented as separate physical entities or as one physical entity performing logically separate functions. Similarly, two servers may be implemented as separate physical entities or as one physical entity performing logically separate functions. Also, a computer may be envisaged as a “terminal” which will be understood to include mobile devices (e.g. mobile phones or PDAs) as well as stationary computers.

What is claimed is:

1. A computer-implemented method for electronic trading of contractual instruments that allocate risks based on the occurrence or non-occurrence of one or more major developments, which comprises:
identifying one or more future major developments with economic impact;
generating one or more digital parameters to indicate whether the major development has or has not occurred;
creating a tradable contractual instrument that is based on the occurrence or non-occurrence of the one or more major developments; and
providing electronic trading of the instrument between buyers and sellers.

2. The method of claim 1, wherein the one or more major developments has a significant economic impact and includes one or more of natural resource access and usage; governmental or business events and transactions; commodity or financial regulatory actions that influence prices and volume of trade, intellectual property protection; international relations; energy price regulations; tax rates and coverage; insurance programs; research and development support; or program expenditures.

3. The method of claim 2, wherein the one or more major developments has a significant economic impact and includes a major event or transaction involving governmental or business entities the operation of which has widespread financial or public welfare implications.

4. The method of claim 3, wherein the major event or transaction of the one or more major developments is a bankruptcy filing, reorganization, liquidation, split, divestiture, combination, merger, takeover, signing a financially significant business deal, change of management, employee layoff, earnings announcement or performance, default or other contractual non-performance, legal problem, liability, court decision, redeployment of resources, natural disaster, change of plans or responsibilities, or receiving guarantees, financial support or debt forgiveness from the U.S. Government.

5. The method of claim 2, wherein the one or more major developments has a significant economic impact and takes the form of actions by legislative, judicial, regulatory bodies, international agreements, election outcomes, or other observable events.

6. The method of claim 1, wherein each digital parameter has a quantifiable dimension.

7. The method of claim 1, further comprising assigning an expiration date for the contractual instrument to facilitate trading.

8. The method of claim 7, wherein expiration dates for related instruments comprise a sequence of future dates.

9. The method of claim 1, wherein the contractual instrument comprises a spot, futures, or options contract.

10. The method of claim 1, further comprising designating a contract value for the contractual instrument to facilitate trading.

11. The method of claim 1, wherein the contractual instrument is traded on a trading platform hosted on one or more computers connected to a computer network that facilitates the posting and viewing of bids and offers for contractual instruments by market participants, and further facilitates the sale of contractual instruments to the extent bids and offers match, thereby establishing a market price for the contractual instrument.

12. The method of claim 11, further comprising monitoring the market price of the contract during a trading day.

13. The method of claim 1, further comprising determining whether the one or more major developments have or have not occurred.

14. The method of claim 13, wherein the determination is made by a committee of experts and is communicated to parties that have traded the instrument.

15. The method of claim 1, further comprising providing payment instructions for triggering a payment of an amount specified in the instrument to a holder upon a determination that the specified occurrence or non-occurrence of one or more major developments have occurred.

16. The method of claim 15, wherein the payment to the holder of the instrument is scaled depending upon how far the occurrence or non-occurrence of the one or more major developments surpasses or falls short of a numeric benchmark.

17. The method of claim 1, wherein identifying one or more future major developments is based on a probability, scale, and time frame associated with the development.

18. A contractual instrument based upon on an occurrence or non-occurrence of one or more major developments, which instrument is in electronic form and is tradable in accordance with the method of claim 1.
